(19) United States
(12) Patent Application Publication
(10) Pub. No.: US 2014/0151916 A1
(43) Pub. Date: Jun. 5, 2014

(54) Method For Making Press-In-Place Gaskets

(71) Applicant: FEDERAL-MOGUL CORPORATION, Southfield, MI (US)

(72) Inventors: Richard Michael Larson, Des Plaines, IL (US); Steven Kueltzo, Aurora, IL (US); John H. Horton, III, Chicago, IL (US); John Robert Stark, Hanover Park, IL (US); Fred Roman, Niles, IL (US)

(73) Assignee: Federal-Mogul Corporation, Southfield, MI (US)

(21) Appl. No.: 13/706,128

(22) Filed: Dec. 5, 2012

(51) Int. Cl. B29C 41/52

(52) U.S. Cl. CPC B29C 41/52
USPC 264/40.1

(57) ABSTRACT

Processes for making press-in-place (PIP) gaskets. Representative components with gasket cavities (grooves) are prepared and the cavities are filled with a curable molding material. Once the molded gaskets are hardened, they are removed from the cavities. The molded sample gaskets are then measured, preferably by a laser scanner, and drawings are prepared based on the measurement data. Appropriate tooling is then created and the gaskets are produced.

### TECHNICAL FIELD

This invention relates to gaskets, and more particularly to the manufacture of press-in-place gaskets.

### BACKGROUND

Gaskets are well known for providing seals between parts and components in vehicles and in engines of all types. For example, gaskets are commonly used today for sealing manifolds, oil pans, valve covers and the like. Many of these gaskets are made of a rubber or elastomeric material, although some are made of a fibrous or felt-type material.

The gaskets come in many styles and types depending on their function and sealing qualities. Some are made of rubber in a uniform shape for various applications, such as O-ring type seals, and some are made of certain shapes and structures specifically for one purpose, such as rocker cover gaskets. Press-in-place (PIP) gaskets are typically installed into a groove or cavity which is cast, molded or machined into the components.

Difficulties arise in trying to replicate PIP, non-rigid type gaskets. Due to the non-rigid nature of these gaskets, they cannot be accurately measured once removed from the mating component. Unless the size and shape of PIP replacement gaskets are perfect, sealing problems could result leading to leakage. Producing a commercially acceptable PIP gasket is often a “hit or miss” effort. The final parts might not fit correctly and the tooling used to make the gaskets might have to be reworked or scrapped.

A method and system for more accurately producing replacement PIP gaskets would be well received in the gasket industry.

### SUMMARY OF THE INVENTION

The present invention provides a unique method for accurately producing commercially acceptable PIP gaskets, particularly for aftermarket replacement. The method starts with obtaining the part or component in which the gasket is to be installed. These parts include one or more grooves in which the gaskets are to be positioned.

A quick-setting or curable molding material, such as a liquid plastic material, is mixed or otherwise provided. The material is poured or otherwise dispensed into the groove in the component. Preferably the groove has been prepared with a mold release material. Once cured (hardened), the formed rigid gasket replica is removed. This creates an accurate, rigid replica of the original gasket which can then be easily scanned.

Once formed and cleared of any flashing and other irregularities, the sample is scanned and measured, typically by a laser scanner. This creates an accurate image of the gasket. Part drawings are then prepared from this data and molds are made to produce copies of the gaskets for marketing.

Further objects, features and benefits of the invention are set forth below in the following description of the invention when viewed in combination with the drawings and claims.

### BRIEF DESCRIPTION OF THE DRAWINGS

FIG. 1 is a perspective view of an engine component and a PIP sealing gasket which for installation in a groove in the component.

FIG. 2 depicts filling a groove in an engine component with a curable liquid material.

FIG. 3 depicts removing the molded gasket replica sample from the groove.

FIG. 4 depicts trimming excess material from the molded gasket replica.

FIG. 5 depicts scanning the gasket replica with a laser scanner.

FIG. 6 depicts a drawing of the gasket replica.

FIG. 7 is a flow chart of an embodiment of the invention.

### DESCRIPTION OF THE PREFERRED EMBODIMENTS

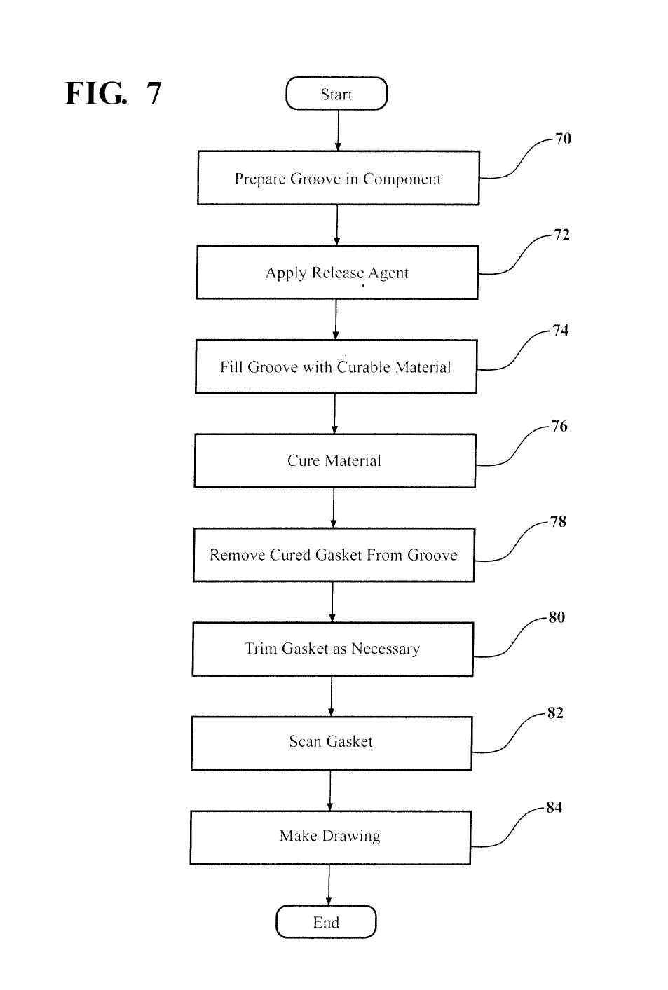

The present inventive process is schematically presented in FIGS. 1-6. A flow chart of a representative embodiment is shown in FIG. 7. The process is used to produce press-in-place (PIP) component gaskets in a more accurate and faster manner. A rigid sample of the gasket is made by the inventive process in the size and shape of the original gasket that was included with the original component.

Problems arise if the sample replacement gasket is not laid out and produced virtually exactly as the original gasket which resided in a groove in an engine component. In this regard, PIP gaskets are utilized in various engine and vehicle components, such as oil pans and valve covers. Other products which commonly use PIP gaskets include water pumps, intake manifolds.

For purposes of the present description of the invention, the process will be described with reference to an oil pan cover. It is to be understood, however, that the inventive process is not to be limited to oil pan covers or to the specific materials or processes described herein. Instead, the following description is being made only by way of example, and the present invention can be used to produce various sizes, shapes and types of gaskets used with virtually any type of product, device or component.

PIP gaskets are designed to be compressed into a groove and provide superior sealing pressure while not overstressing the material. The gaskets are typically used in metal-to-metal joints and are also known as “non-rigid” PIP gaskets. PIP gaskets are self-retaining and do not require adhesives to stay in place. They are also easy to install and typically resistant to normal oils, cooling liquids, salt water, dust, dirt and intake air. PIP gaskets also typically can be used in environments which have a wide range of temperatures, such as −60° C. to 220° C.

The materials used for PIP gaskets include most rubber and elastomeric materials. These include silicone rubber, nitrite, polyacrylate acrylic rubber, some flouroelastomers and nitrile butadiene rubber.

Gasket members for engines and other products, such as oil pans and valve covers, have a certain durability and life span. The expected life span can be altered by a number of factors, such as heat and toxic fluids. In any event, it is known that gaskets for vehicle components often wear out and need replacing. The present invention is designed to manufacture and produce gaskets that can replace the original equipment gaskets and perform as well or better than the original equipment gaskets—and do so in a faster and more accurate manner.

One known method of producing replacement gaskets is to attempt to measure and draw the actual groove in the actual component. Not only is this time consuming and expensive, but it also can be significantly inaccurate. Similarly, trying to accurately measure the original gasket after it has been removed from the component is time-consuming and typically inaccurate. On many occasions, using either of these known processes, the final gaskets will not fit properly. This can result in the tooling being reworked or scrapped, causing wasteful expense.

A representative engine component 10 is shown in FIG. 1. In this example, the component is an oil pan cover. The cover 10 is made of a metal material, such as aluminum or steel, and has a groove 12 formed in a surface 14 which mates with another oil pan component.

The gasket 20 which is pressed into the groove during manufacturing, is shown in FIG. 1 and positioned above the groove 12. In use, the gasket 20 is pressed into the groove manually or by a conventional manufacturing procedure.

In the inventive process and system herein for making replacement gaskets, the original gasket is first removed from the component. Typically it is worn, torn, or not in its original shape. The groove 12 is then cleaned in order to remove any debris or residue. This can be done mechanically or manually, as desired.

It is also possible to obtain a new factory-made product or component and use that for producing the replacement gasket, although this creates an unnecessary expense. With new products, the grooves also will need to be cleared and thoroughly cleaned.

The groove 12 is then prepared by spraying or otherwise applying a release agent into it. This allows for ease of removal of the sample gasket after it has hardened. A preferred release agent which can be used for this purpose is spray silicone although there are other known release agents which could be used for this same purpose.

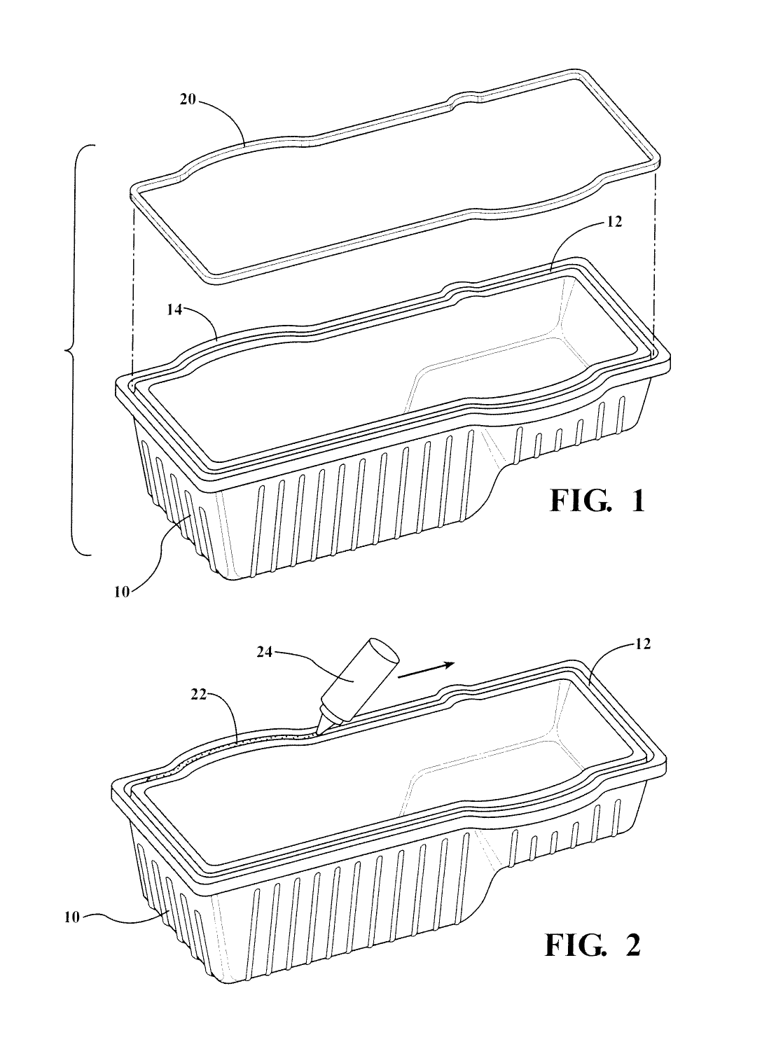

Once the groove 12 is cleaned and prepared with a release agent, a curable material 22 is placed into the groove 12. This step is shown in FIG. 2. The material preferably is a mixable 2-part liquid plastic material, such as “Smooth on Epoxy Resin”, but it can be any material which performs the same function and achieves the same result. The molding material could also be clay, or an epoxy resin.

The material is mixed (if required), poured or dispensed into the groove 12, and then allowed to cure or harden. The material can be cured in any conventional way, over a certain time period, with added heat, with ultraviolet light, or the like, as required for the material utilized.

The procedure by which the material 22 is positioned in the groove 12 also is not critical. The material could simply be manually poured into the groove from a cup or dish of some type, or by use of a mechanical dispenser device, such as the device 24 shown in FIG. 2. For manual dispensing, a cooking baster, a caulking tube application device, or a hydraulic syringe needle could be utilized. It is preferred that the filling of the groove be carried out in a slow and steady manner. This provides a more uniform fill of the groove.

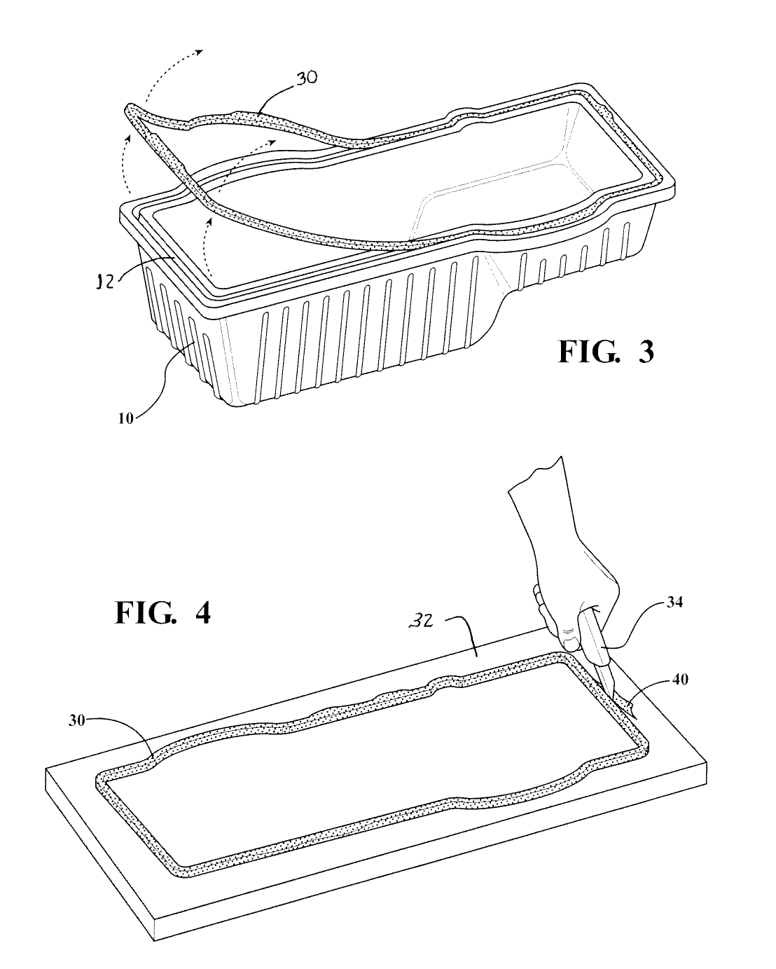

Once the material has cured and hardened in the groove, it is removed. This is shown in FIG. 3. The cured rigid sample gasket 30 is removed carefully from the groove 12, preferably manually in order to prevent damage to it.

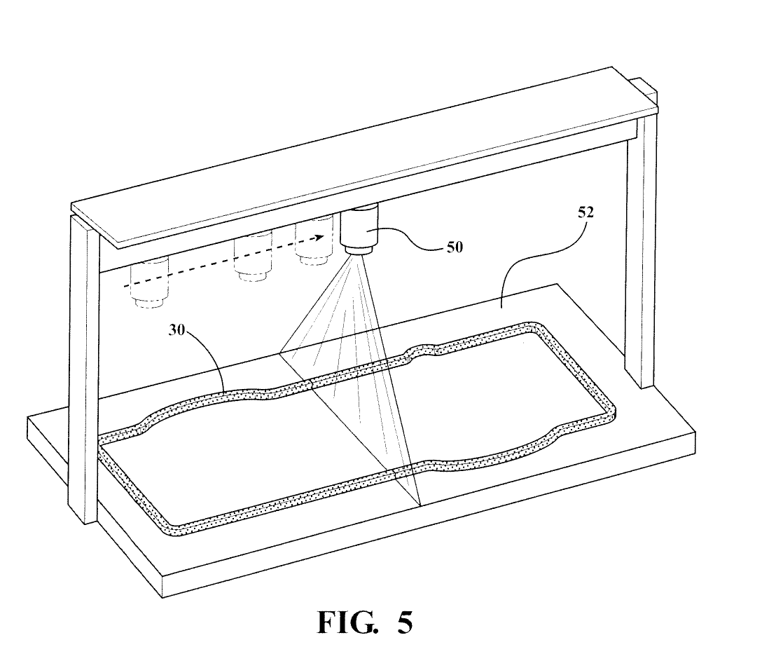

The sample gasket member 30 is then inspected to make sure that it is a useable product. Any external material, such as flashing or other irregularities, are removed. One manner in which this can be accomplished is shown in FIG. 4. The sample gasket 30 is positioned on a flat table or surface 32 and a knife 34 or other implement is used to trim off the unnecessary items, such as flash 40. The edges and surfaces of the sample gasket 30 can also be smoothed, such as by rubbing or light sanding.

Once the sample gasket is trimmed and finished, its shape and dimensions are recorded. This preferably is done with a laser scanner 50 as shown in FIG. 5. The gasket 30 is positioned on an appropriate surface, such as table 52, and the laser scanner is programmed to move over the sample gasket 30 and record its size, shape and pertinent dimensions. A 2-D or 3-D image can be made of the sample gasket.

Applicable 2-D scanners include Fabrivision scanners and table top scanners. 3D scanners include Steinbichler, Solution NIX, Creaform, ComScan, Capture 3D and 2-Corp. A preferred software used to operate a scanner for this purpose is Rapidform.

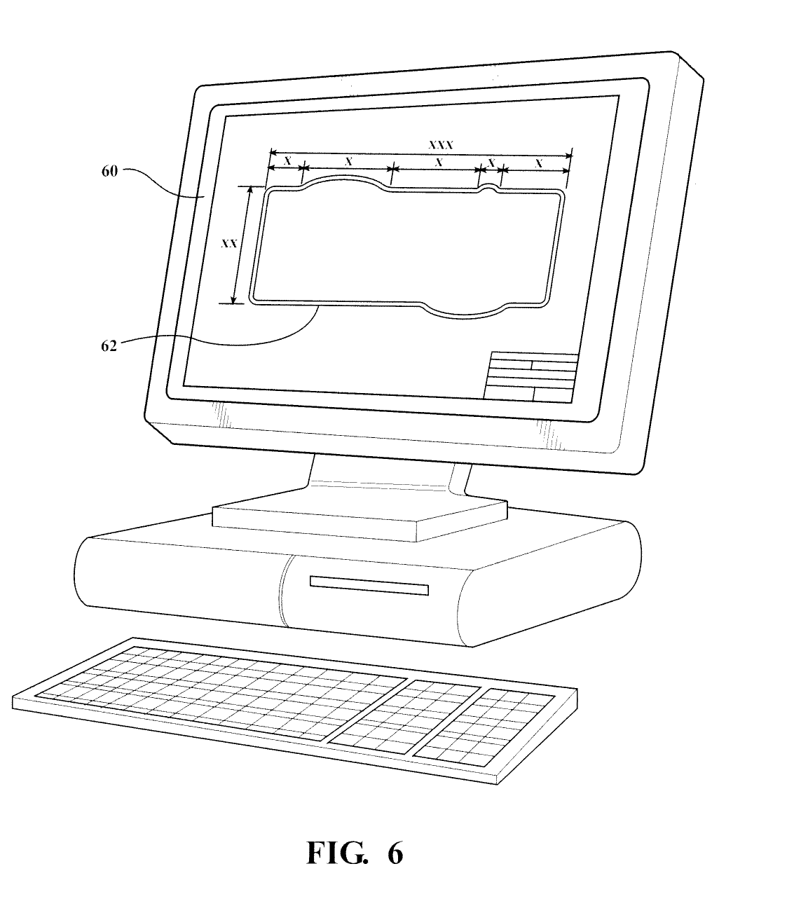

Based on the measured sample, drawings are made of the final gasket. These can be part and/or production drawings. A representative drawing 60 is shown in FIG. 6. The sample gasket is depicted as FIG. 62 on the drawing 60.

Once the production drawings of the gasket are made, molds and tooling (not shown) are made in a conventional manner. The replacement gaskets are then produced by use of the tooling.

FIG. 7 is a flow chart of a representative embodiment of the invention. After an actual grooved component is secured and the groove is cleaned and prepared 70, an appropriate release agent is applied in the groove 72. The curable material is then dispensed into the groove cavity 74 and the material is cured (hardened) 76. Once the sample gasket is cured, it is removed from the groove 78 and trimmed as necessary 80.

The final sample gasket is then measured and scanned 82, such as with a laser scanner. One or more drawings are then prepared 84 from the measurements and data made and supplied by the scanner.

Molds (tooling) can be prepared from the drawings and production gaskets can be produced for marketing.

Although the invention has been described with respect to preferred embodiments, it is to be also understood that it is not to be so limited since changes and modifications can be made therein which are within the full scope of this invention as detailed by the following claims.

What is claimed is:

1. A process for producing a gasket member, said process comprising the steps of:
(a) filling a groove cavity in a product with a liquid curable molding material;
(b) allowing said material to cure to form a sample gasket member;
(c) removing the cured gasket member from the groove member; and
(d) measuring the size and shape of the gasket member.

2. The process as described in claim 1 further comprising the step of preparing and cleaning the groove cavity prior to step (a).

3. The process as described in claim 1 further comprising curing the liquid curable molding material with heat, time or light.

4. The process as described in claim 1 further comprising the step of applying a release agent in the groove cavity prior to step (a).

5. The process as described in claim 1 wherein step (c) comprises manually removing the cured gasket member.

6. The process as described in claim 1 wherein step (d) comprises scanning the gasket member with a laser scanner.

7. The process as described in claim 6 further comprising securing electronic data relative to the precise size and shape of the gasket member.

8. The process as described in claim 1 further comprising:
(e) making drawings of the sample gasket member based on the measurements made in step (d).

9. The process as described in claim 1 further comprising making tooling for production of other gasket members, said tooling based on the measurements made in step (d).
